(19) United States
(12) Patent Application Publication
(10) Pub. No.: US 2020/0143378 A1
(43) Pub. Date: May 7, 2020

(54) METHOD AND DEVICE FOR OUTPUTTING RISK INFORMATION AND CONSTRUCTING RISK INFORMATION

(71) Applicant: Alibaba Group Holding Limited, George Town (KY)

(72) Inventors: Luyi YANG, Hangzhou (CN); Qing LU, Hangzhou (CN); Lei YUN, Hangzhou (CN); Wenwen WANG, Hangzhou (CN); Yang CUI, Hangzhou (CN)

(73) Assignee: Alibaba Group Holding Limited, George Town (KY)

(21) Appl. No.: 16/722,609

(22) Filed: Dec. 20, 2019

Related U.S. Application Data
(63) Continuation of application No. 16/140,039, filed on Sep. 24, 2018.
Application No. 16/140,039 is a continuation of application No. PCT/CN2017/077248, filed on Mar. 20, 2017.

(30) Foreign Application Priority Data
Mar. 25, 2016 (CN) 201610176988.6

(51) Int. Cl. G06Q 20/40; G16Z 99/00

(52) U.S. Cl. CPC G06Q 20/4016; G16Z 99/00; G06Q 20/4014; G06Q 20/4093

(57) ABSTRACT

The present application discloses methods and devices for providing risk information. A risk factor corresponding to a risk control decision result of a service that matches service data for a corresponding risk factor is determined. The risk factors are associated with risk control rules and a risk control model identifying relationships between risk factors and risk control decision results. A risk information set corresponding to the risk factor is determined that includes levels of risk information having different refinement degrees and including information explaining a cause of the risk control decision result. The levels of risk information are determined from the levels of risk information based on a risk information requirement level of a service owner of the service. The levels of risk information have refinement degrees matching the risk information requirement level of the service owner. The levels of risk information are provided to the service owner.

### CROSS-REFERENCE TO RELATED APPLICATIONS

This application is a continuation of U.S. application Ser. No. 16/140,039, filed on Sep. 24, 2018, which is a continuation of PCT Application No. PCT/CN2017/077248, filed on Mar. 20, 2017, which claims priority to Chinese Patent Application No. 201610176988.6, filed on Mar. 25, 2016, and each application is hereby incorporated by reference in its entirety.

### TECHNICAL FIELD

The present application relates to the field of information technologies, and in particular, to a method and device for outputting risk information and constructing risk information.

### BACKGROUND

With the rapid development of information technologies, many services can be performed on the Internet, bringing convenience to people's lives but also causing risks to the services performed on the Internet. For example, some services may be illegal, some other services may be legal, but illegal users can impersonate as legal users to perform the services. In this case, a service platform on the Internet usually performs risk control on a service performed on the service platform, based on a predetermined risk control rule and/or risk control model, to obtain a risk control decision result, and output the risk control decision result to a service owner, so that the service owner subsequently processes the service based on the risk control decision result. The risk control decision result can be rejecting the service, accepting the service, etc.

In the existing technology, corresponding risk information can also be output to the service owner when the risk control decision result is output. The risk information is used to explain a cause of the risk control decision result. Currently, service platforms generally simply translate applied risk control rules in advance, and then output the translated risk control rules to owners of services as risk information.

However, in actual applications, different owners of a service have different industry experience and risk control capabilities. Correspondingly, risk information requirement degrees or depths of different owners of the service may be different. However, such difference is not considered when risk information is output in the existing technology. Therefore, the risk information output in the existing technology has poor applicability to different owners of a service.

### SUMMARY

Implementations of the present application provide a method and device for outputting risk information and constructing risk information, to resolve a problem that risk information output in the existing technology has poor applicability to different owners of a service.

An implementation of the present application provides a method for outputting risk information, including: determining, based on a predetermined risk control rule and/or risk control model that include/includes one or more risk factors, a risk factor that corresponds to a risk control decision result of a service from the risk factors, where the risk control decision result is determined based on the risk control rule and/or risk control model and service data that relates to the corresponding risk factor; determining a risk information set that corresponds to the corresponding risk factor, where the corresponding risk information set includes multiple levels of risk information with different refinement degrees, and the risk information is used to explain a cause of the risk control decision result; determining one or more levels of risk information with refinement degrees that match a risk information requirement level of a service owner from the multiple levels of risk information based on the risk information requirement level of the service owner; and outputting the determined risk information, so that the service owner obtains the determined risk information.

An implementation of the present application provides a device for outputting risk information, including: a risk factor determining module, configured to determine, based on a predetermined risk control rule and/or risk control model that include/includes one or more risk factors, a risk factor that corresponds to a risk control decision result of a service from the risk factors, where the risk control decision result is determined based on the risk control rule and/or risk control model and service data that relates to the corresponding risk factor; a first risk information determining module, configured to determine a risk information set that corresponds to the corresponding risk factor, where the corresponding risk information set includes multiple levels of risk information with different refinement degrees, and the risk information is used to explain a cause of the risk control decision result; a second risk information determining module, configured to determine one or more levels of risk information with refinement degrees that match a risk information requirement level of a service owner, based on the risk information requirement level of the service owner, from the multiple levels of risk information; and a risk information output module, configured to output the determined risk information, so that the service owner obtains the determined risk information.

An implementation of the present application provides a method for constructing risk information, including: splitting a predetermined risk control rule and/or risk control model, to obtain one or more risk factors included in the risk control rule and/or risk control model; and constructing a corresponding risk information set for each obtained risk factor, where the corresponding risk information set includes multiple levels of risk information with different refinement degrees. The risk information is used to explain a cause of a risk control decision result of a service, and the risk control decision result is determined based on the risk control rule and/or risk control model and service data that relates to the corresponding risk factor, so that one or more levels of risk information with refinement degrees that match a risk information requirement level of a service owner are determined from the multiple levels of risk information based on the risk information requirement level of the service owner, and are output to the service owner when the risk control decision result is output.

An implementation of the present application provides a device for constructing risk information, including: a risk factor acquisition module, configured to split a predetermined risk control rule and/or risk control model, to obtain one or more risk factors included in the risk control rule and/or risk control model; and a risk information construction module, configured to construct a corresponding risk information set for each obtained risk factor, where the corresponding risk information set includes multiple levels of risk information with different refinement degrees, the risk information is used to explain a cause of a risk control decision result of a service, and the risk control decision result is determined based on the risk control rule and/or risk control model and service data that relates to the corresponding risk factor, so that one or more levels of risk information with refinement degrees that match a risk information requirement level of a service owner are determined from the multiple levels of risk information based on the risk information requirement level of the service owner and are output to the service owner when the risk control decision result is output.

According to one or more of the previous technical solutions in the implementations of the present application, multiple levels of risk information with different refinement degrees corresponding to the risk factor can be constructed for each risk factor to satisfy different levels of risk information requirement degrees and/or depths of different owners of a service. In addition, different risk information requirement levels can be used to indicate different levels of risk information requirement degrees and/or depths. Further, one or more levels of risk information with refinement degrees that match a risk information requirement level of an owner of a service can be determined from the multiple levels of risk information based on the risk information requirement level of the service owner and be output when risk information is output, so that the service owner obtains the output risk information. Therefore, risk information output in the solutions of the present application has better applicability to different owners of a service, so that the problem in the existing technology can be partially or completely resolved.

### BRIEF DESCRIPTION OF DRAWINGS

The accompanying drawings described here are used to facilitate understanding of the present application, and constitute a part of the present application. Example implementations of the present application and descriptions of the implementations are used to explain the present application, and constitute no improper limitation to the present application. In the accompanying drawings:

FIG. 1 illustrates a process of a method for outputting risk information, according to an implementation of the present application;

FIG. 2 is a part of a schematic diagram illustrating risk information sets constructed for risk factors in a risk control scenario of a payment service, according to an implementation of the present application;

FIG. 3 is a part of a schematic diagram illustrating risk information sets constructed for risk factors in a risk control scenario of a payment service, according to an implementation of the present application;

FIG. 4 illustrates a process of a method for constructing risk information, according to an implementation of the present application;

FIG. 5 is a schematic structural diagram illustrating a hierarchical infocode output module configured to output risk information in a risk control scenario of a payment service, according to an implementation of the present application;

FIG. 6 is an example diagram illustrating a three-layer infocode framework in a risk control scenario of a payment service, according to an implementation of the present application;

FIG. 7 is a schematic structural diagram illustrating a device for outputting risk information corresponding to FIG. 1, according to an implementation of the present application;

FIG. 8 is a schematic structural diagram illustrating a device for constructing risk information corresponding to FIG. 4, according to an implementation of the present application; and

FIG. 9 is a flowchart illustrating an example of a computer-implemented method for determining and providing one or more levels of risk information for risk factors corresponding to a risk control decision result of a service owner, according to an implementation of the present disclosure.

### DESCRIPTION OF IMPLEMENTATIONS

To make the objectives, technical solutions, and advantages of the present application clearer, the following clearly and completely describes the technical solutions of the present application with reference to the specific implementations and the corresponding accompanying drawings of the present application. Apparently, the described implementations are some rather than all of the implementations of the present application. All other implementations obtained by a person of ordinary skill in the art based on the implementations of the present application without creative efforts shall fall within the protection scope of the present application.

As mentioned in the background, risk information can be used to explain a cause of a corresponding risk control decision result, and risk information requirement degrees or depths of different owners of a service may be different.

For example, an owner of a service is a merchant that corresponds to a service. Experienced merchants prefer to see various risk signals of services behind risk control decision results, that is, prefer to see (more detailed, in-depth, etc.) risk information with a higher refinement degree, to improve their own risk control levels and understand current risk trends. New merchants in the industry are more engaged in market expansion, and have no professional team for receiving and processing professional risk information output. In this case, (more macro, simpler, etc.) risk information with a lower refinement degree is easy to understand and therefore is more suitable for such merchants.

However, such difference is not considered when risk information is output in the existing technology. Therefore, the output risk information may have poor applicability to different owners of a service.

To resolve the problem in the existing technology, a core idea of the solutions of the present application is as follows: Multiple levels of risk information with different refinement degrees are constructed to satisfy different levels of risk information requirement degrees and/or depths of different owners of a service, thereby improving applicability of output risk information to different owners of the service. Different levels of risk information requirement degrees and/or depths can be indicated by using different risk information requirement levels. The multiple levels of risk information can be constructed based on historical risk control experience. The solutions of the present application are described below in detail.

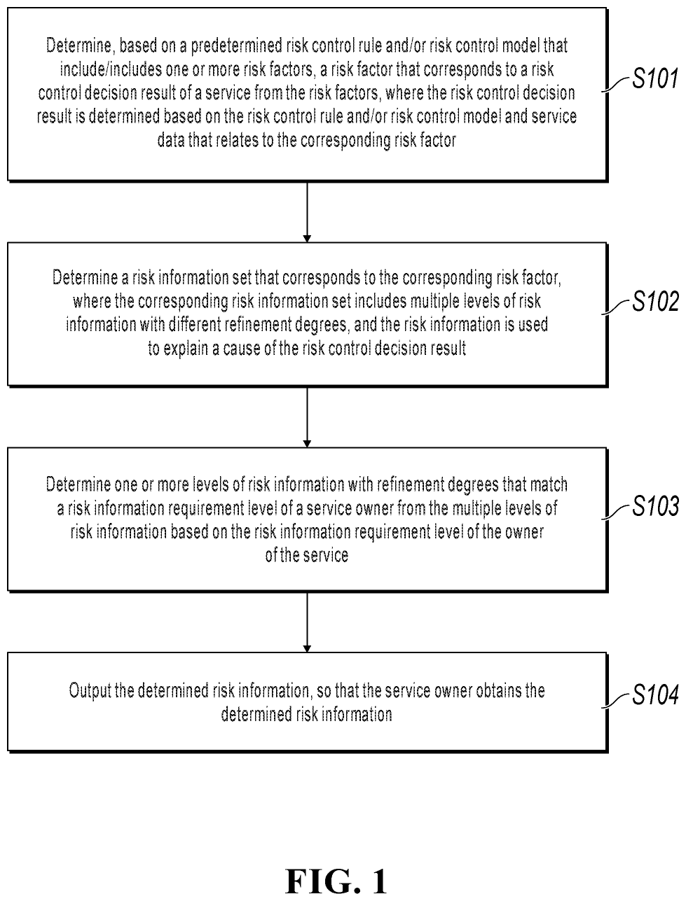

FIG. 1 illustrates a process of a method for outputting risk information, according to an implementation of the present application. The process can be performed by a server or a terminal device. To be more specific, the process can be performed by a function module configured to output risk information on the server or the terminal device. A device that can be used as the server includes, but is not limited to, a personal computer, a medium- or large-sized computer, a computer cluster, etc. A device that can be used as the terminal device includes, but is not limited to, a mobile phone, a tablet computer, a smartwatch, an in-vehicle mobile station, a personal computer, etc. The execution body constitutes no limitation to the present application. For ease of description, in this implementation of the present application, for example, the execution body is the server.

The process in FIG. 1 can include the following steps.

S101. Determine, based on a predetermined risk control rule and/or risk control model that include/includes one or more risk factors, a risk factor that corresponds to a risk control decision result of a service from the risk factors, where the risk control decision result is determined based on the risk control rule and/or risk control model and service data that relates to the corresponding risk factor.

In this implementation of the present application, the service can be “one service”, and the process in FIG. 1 can be performed once for each service.

In this implementation of the present application, risk control can be performed on the service based on the risk control rule and/or risk control model, to obtain the risk control decision result. The risk control rule is usually executed by the risk control model, or the risk control model can include the risk control rule. In actual applications, the risk control rule and the risk control model can be considered as a risk policy system.

With the increasing complexity of network services, when risk control is performed on a service, it is difficult to accurately prevent and control risks based on simple risk behavior description. Therefore, the current risk control rule can be a single behavioral characteristic in some simple scenarios, but in most scenarios, it is a combination of multiple behavioral characteristics. A process of performing risk control on a service is a process of correspondingly matching behavioral characteristics (which can be extracted from data related to the service) of the service with behavioral characteristics of a risk control rule, so that a decision can be made based on a matching result, to determine a risk control decision result.

Further, each behavioral characteristic can be summarized by using one risk factor. In this case, the risk control rule can include one or more risk factors. Correspondingly, the risk control rule can be split into one or more risk factors. Similarly, the risk control model can also include one or more risk factors.

In this implementation of the present application, the service data that relates to the corresponding risk factor can be service data that reflects a behavioral characteristic that corresponds to the risk factor. The risk control decision result can correspond to one or more risk factors. If a risk control decision result of a service is caused by service data reflecting behavioral characteristics that correspond to one or several risk factors, it can be considered that the risk control decision result corresponds to the one or several risk factors.

The risk decision result of the service can include rejecting the service, accepting the service, needing to manually review the service, etc.

S102. Determine a risk information set that corresponds to the corresponding risk factor, where the corresponding risk information set includes multiple levels of risk information with different refinement degrees, and the risk information is used to explain a cause of the risk control decision result.

Because different risk factors correspond to different behavioral characteristics, different risk information can be used to explain causes of risk decision results that correspond to different risk factors.

As described above, a correspondence between a risk factor and risk information can be pre-established based on this. In this implementation of the present application, one corresponding risk information set can be pre-constructed for each risk factor. The risk information set can include multiple levels of risk information with different refinement degrees. The risk factor that corresponds to the risk information set is a risk factor that corresponds to the multiple levels of risk information included in the risk information set.

It is worthwhile to note that in the present application, that the risk information set includes the multiple levels of risk information can mean that the multiple levels of risk information have been constructed and stored in the risk information set, or the multiple levels of risk information have not yet been constructed but materials used to construct the multiple levels of risk information have been prepared in the risk information set. The multiple levels of risk information can be constructed in real time based on these materials before being output when the multiple levels of risk information need to be output.

In this implementation of the present application, multi-level risk information can be multiple levels of risk information, and the multiple levels of risk information can be refined layer by layer. For example, risk information at a top layer is macro and general, and risk information at a next layer is a further refinement (a detailed explanation, an expansion for some new content, etc.) of the risk information at the top layer. By analogy, except the risk information at the top layer, risk information at each layer can be a further refinement of risk information at a previous layer.

Certainly, there may be no “layer-by-layer refinement” association relationship between the multiple levels of risk information. For example, each level of risk information can be independently constructed. In this case, risk information at a current layer is not necessarily constructed based on risk information at a previous layer.

In this implementation of the present application, the multiple risk information levels can be obtained through division based on historical risk control experience, a requirement of a service owner, etc. There can be different division methods for different services. A specific division method of the multiple risk information levels is not limited in the present application.

S103. Determine one or more levels of risk information with refinement degrees that match a risk information requirement level of a service owner, from the multiple levels of risk information based on the risk information requirement level of the service owner.

In this implementation of the present application, the risk information requirement level of the service owner can be used to indicate a risk information requirement degree and/or depth of the service owner.

In actual applications, the risk information requirement level of the service owner can be inferred by the server from historical data, can be specified by the service owner, etc. In the former method, operations of the service owner can be reduced, so that convenience is higher. In the latter method, an opinion of the owner is directly adopted, so that accuracy is higher. A specific number and a specific division method of risk information requirement levels are not limited in the present application.

In this implementation of the present application, risk information requirement levels of different owners of the service may be different. Correspondingly, risk information at corresponding levels can be separately output to different owners, to separately satisfy requirements of different owners.

Further, for the multiple levels of risk information, each risk information requirement level can uniquely match one of the multiple levels of risk information, or can simultaneously match two, even more, of the multiple levels of risk information.

S104. Output the determined risk information, so that the service owner obtains the determined risk information.

In this implementation of the present application, the determined risk information can be directly output to the service owner. The risk information can be output to another device or function module, and then the risk information is sent by the another device or function module to the service owner. Alternatively, the risk information can be pre-stored, and then the risk information is output after a passive wait for the service owner to query the risk information, etc.

In this implementation of the present application, the risk control decision result and the risk information determined for the risk control decision result can be output by one device, or can be separately output by different devices. Implementations are not limited in the present application. Further, output moments and an output sequence of the risk control decision result and the risk information are not limited in the present application. The risk information can usually be output when the risk control decision result is output, so that the service owner can know the cause of the risk control decision result in a timely way.

According to the previous method, multiple levels of risk information with different refinement degrees corresponding to the risk factor can be constructed for each risk factor to satisfy different levels of risk information requirement degrees and/or depths of different owners of a service. In addition, different risk information requirement levels can be used to indicate different levels of risk information requirement degrees and/or depths. Further, one or more levels of risk information with refinement degrees that match a risk information requirement level of an owner of a service can be determined from the multiple levels of risk information based on the risk information requirement level of the service owner and be output when risk information is output, so that the service owner obtains the output risk information. Therefore, risk information output in the solutions of the present application has better applicability to different owners of a service, so that the problem in the existing technology can be partially or completely resolved.

Based on the previous method, this implementation of the present application further provides some specific implementation solutions and an extension solution of the previous method, which are described below.

In this implementation of the present application, as described above, a correspondence can be established between each risk factor included in the risk control rule and/or risk control model and one predetermined risk information set. In this case, for step S102, the determining a risk information set that corresponds to the corresponding risk factor can include the following: determining the risk information set that corresponds to the corresponding risk factor from predetermined risk information sets based on the correspondence.

Certainly, alternatively, instead of being pre-constructed, the risk information set can be constructed in real time when the risk information needs to be used. In this case, for step S102, the determining a risk information set that corresponds to the corresponding risk factor can include the following: constructing the risk information set that corresponds to the corresponding risk factor based on the corresponding risk factor.

In this implementation of the present application, information about the risk information requirement level of the service owner is used in a process of performing step S103. For ease of implementing the solutions of the present application, two methods for obtaining the information about the risk information requirement level are provided below as examples.

Method 1: The service owner or the server can pre-specify the risk information requirement level of the service owner, and then write the information about the specified risk information requirement level to a predetermined configuration file. In this case, before step S103, the risk information requirement level can be read from the predetermined configuration file. In Method 1, operations of the service owner can be reduced, so that convenience is higher.

Method 2: The server can infer the risk information requirement level of the service owner in real time when step S103 needs to be performed. The server can infer the risk information requirement level of the service owner from obtained risk control level information and/or risk control requirement information of the service owner. In Method 2, reference is made to the information related to the service owner, so that accuracy is higher.

It is worthwhile to note that a method for obtaining the risk control level information and/or risk control requirement information is not limited in the present application. The risk control level information and/or risk control requirement information can be collected by the server during historical interaction with the service owner, can be known by a service side manager through communication with the service owner, and then be output to the server, etc.

In this implementation of the present application, for step S104, several implementations have been provided above. In actual applications, one common implementation is as follows:

The outputting the determined risk information can include the following: outputting the determined risk information to the service owner when outputting the risk control decision result to the service owner. This implementation has the following advantage: The service owner can relatively synchronously see the corresponding risk information when seeing the risk control decision result, so that the service owner has better experience, and performs targeted subsequent processing on the service based on the transaction information, for example, re-submits the service after the risk is eliminated.

Both the “multiple levels of risk information” and the “risk information requirement level” are focuses of the solutions in the present application. For ease of understanding, the “multiple levels of risk information” and the “risk information requirement level” are separately further described here.

In this implementation of the present application, the risk information requirement level of the service owner is one of multiple predetermined risk information requirement levels, and it is used to indicate a risk information requirement degree and/or depth of the service owner. The multiple risk information requirement levels can be in a one-to-one correspondence with and match the multiple levels of risk information, and a risk information requirement level that indicates a higher risk information requirement degree and/or depth can match a level of risk information with a higher refinement degree in the multiple levels of risk information.

For example, the service is a payment service, and the service owner is a merchant that corresponds to the payment service. The payment service can be mainly performed based on a third-party payment platform, or can be mainly performed based on a payment platform provided by a bank.

All merchants in a payment service scenario can be classified into three types. A type of merchant with a relatively low risk information requirement degree and/or depth is referred to as “weak management and control merchant”. A type of merchant with a relatively moderate risk information requirement degree and/or depth is referred to as “general management and control merchant”. A type of merchant with a relatively high risk information requirement degree and/or depth is referred to as “strong management and control merchant”.

Correspondingly, the multiple levels of risk information can be three levels of risk information. When the risk information is output, if the service owner is a weak management and control merchant, a level of risk information with the lowest refinement degree can be output. If the owner is a general management and control merchant, a level of risk information with a moderate refinement degree can be output. If the owner is a strong management and control merchant, a level of risk information with the highest refinement degree can be output.

In this implementation of the present application, the multiple levels of risk information can be constructed based on the risk control rule and/or risk control model and related historical risk control experience data, and are described by using a method that can be easily understood by the service owner.

Historical risk control experience can include experience summarized by the server in risk control processes for historical services, available experience provided by the service owner, etc. For example, the server can infer, from information provided by the service owner, risk information needed by the owner or similar owners, and risk information that can be easily understood by the owner or similar owners. Alternatively, the service owner can actively notify the server of risk information needed by the owner and a risk information description method that can be easily understood by the owner. All the data can be used as the historical risk control experience data.

The risk information can be information in a form of program code, or can be information in a form of a natural language. In the existing technology, the risk control rule is used as the risk information after being simply translated. However, in the solutions of the present application, the risk information can be described in an easy-to-understand language based on the historical risk control experience, and therefore can be easily understood by the service owner. Therefore, risk information output based on the solutions of the present application has better applicability.

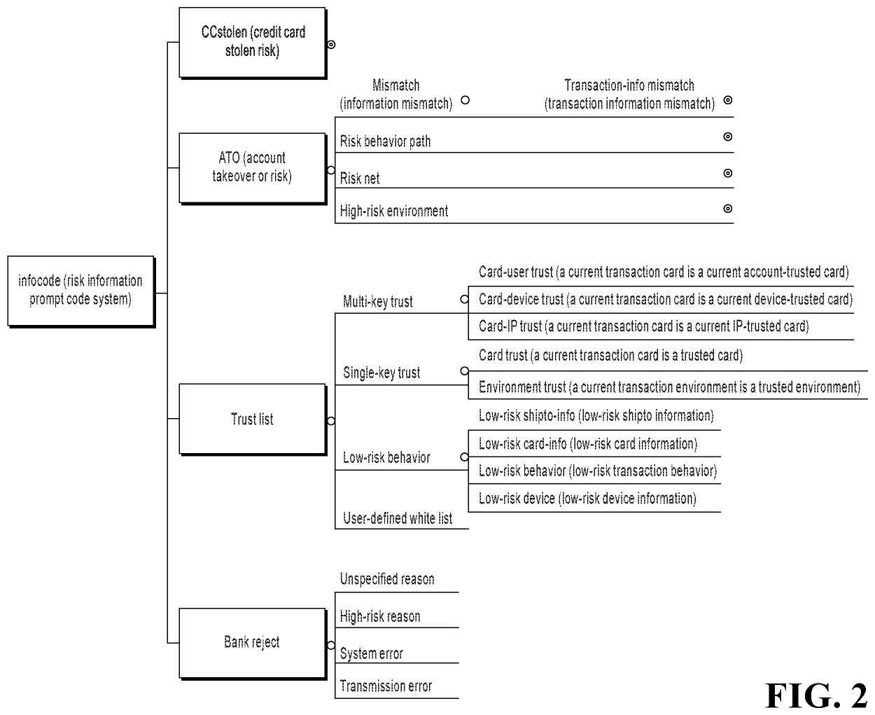

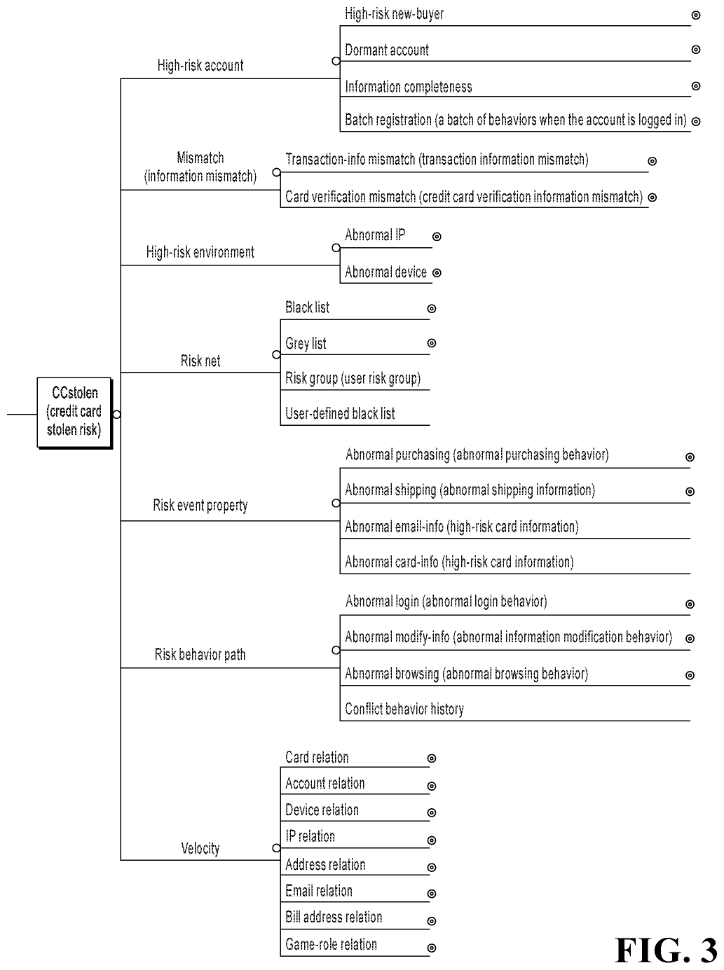

As shown in FIG. 2 and FIG. 3, an implementation of the present application provides a schematic diagram illustrating risk information sets constructed for risk factors in a risk control scenario of a payment service. FIG. 2 and FIG. 3 each are a part of the schematic diagram illustrating the risk information sets. Subnodes of “credit card stolen risk” in FIG. 2 are shown in FIG. 3.

In this scenario, risk information is referred to as “risk information prompt code (infocode)”, and the risk information sets constructed for the risk factors are collectively referred to as “infocode system”. It is worthwhile to note that the two names are merely examples and constitute no limitation to the present application. In another scenario, other names can be used.

In FIG. 2 and FIG. 3, a tree structure is used to indicate the infocode system. The “risk information prompt code system” node is a root node of the tree structure. There are four branches in total at a second layer of the tree structure. Each branch is an infocode set. These infocode sets are respectively a set including content of a “credit card stolen risk” node and content of all subnodes of the “credit card stolen risk” node, a set including content of an “account takeover risk” node and content of all subnodes of the “account takeover risk” node, a set including content of a “trust list” node and content of all subnodes of the “trust list” node, and a set including content of a “bank reject” node and content of all subnodes of the “bank reject” node.

Each infocode set corresponds to one risk factor (the risk factor is not shown). Each infocode set includes multiple levels of infocode. From the second layer of the tree structure, each layer is one of multiple levels of infocode, and a lower-level infocode has a higher refinement degree.

The infocode set that includes the “credit card stolen risk” node is used as an example. It can be seen in FIG. 3 that the infocode set includes three levels of infocode. First-level infocode includes the content of the “credit card stolen risk” node. Second-level infocode includes content of seven nodes: “high-risk account”, “information mismatch”, “high-risk environment”, “risk net”, “risk event property”, “risk behavior path”, and “velocity”.

It can be seen that the second-level infocode is a further refinement of the first-level infocode. Similarly, the third-level infocode is a further refinement of the second-level infocode. For example, content of the “high-risk account” node in the second-level infocode is refined into content of four nodes: “high-risk new-buyer”, “dormant account”, “information completeness”, and “a batch of behaviors when the account is logged in” in the third-level infocode. Content of the “information mismatch” node in the second-level infocode is refined into content of two nodes: “transaction information mismatch” and “credit card verification information mismatch” in the third-level infocode.

It can be seen from FIG. 2 and FIG. 3 that infocode with a higher refinement degree can give a more specific explanation of a cause of a risk control decision result.

It is worthwhile to note that content of the nodes in FIG. 2 and FIG. 3 may not be completely shown. FIG. 2 and FIG. 3 are merely examples of multiple levels of infocode, and constitute no limitation to the present application.

The method for outputting risk information provided in the implementations of the present application is described above in detail. Based on the same idea, an implementation of the present application further provides a method for constructing risk information.

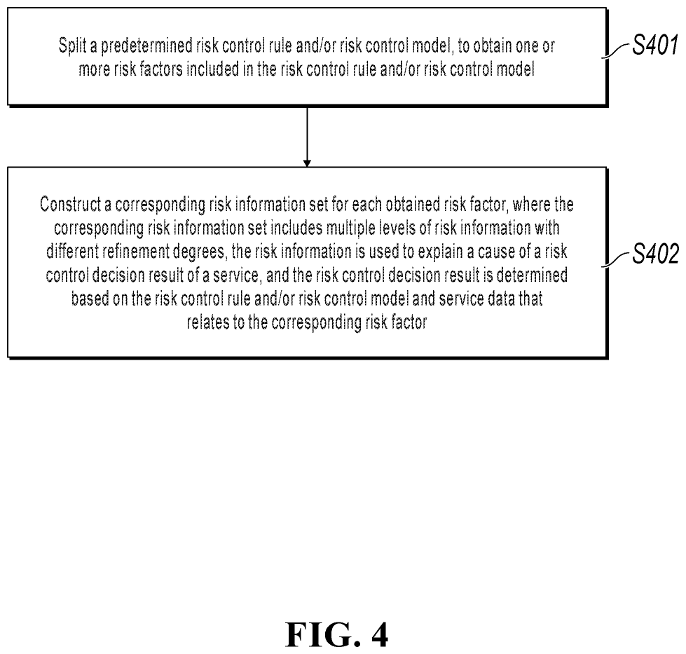

FIG. 4 shows a process of the method for constructing risk information. An execution body of the process can be the same as the execution body of the process in FIG. 1.

The process in FIG. 4 can include the following steps:

S401. Split a predetermined risk control rule and/or risk control model, to obtain one or more risk factors included in the risk control rule and/or risk control model.

S402. Construct a corresponding risk information set for each obtained risk factor, where the corresponding risk information set includes multiple levels of risk information with different refinement degrees. The risk information is used to explain a cause of a risk control decision result of a service, and the risk control decision result is determined based on the risk control rule and/or risk control model and service data that relates to the corresponding risk factor, so that one or more levels of risk information with refinement degrees that match a risk information requirement level of a service owner are determined from the multiple levels of risk information based on the risk information requirement level of the service owner, and are output to the service owner when the risk control decision result is output.

According to the method in FIG. 4, output risk information has better applicability to different owners of a service, so that the problem in the existing technology can be partially or completely resolved.

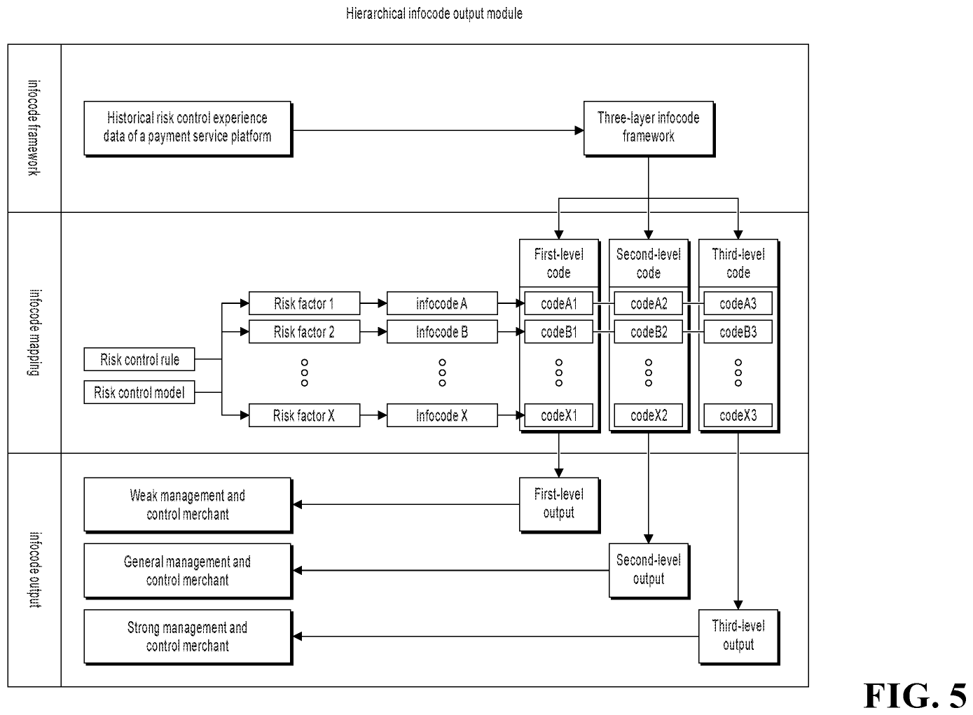

Based on the same idea, as shown in FIG. 5, an implementation of the present application further provides a schematic structural diagram illustrating a hierarchical infocode output module configured to output risk information in a risk control scenario of a payment service.

The module in FIG. 5 can be mainly divided into three parts.

A first part is an infocode framework used to construct a three-layer infocode framework based on historical risk control experience data of a payment service platform. Multiple levels of risk information are constructed based on the three-layer infocode framework.

A second part is an infocode mapping. Here, “mapping” is mainly a correspondence between risk factors (risk factor 1, risk factor 2, . . . , and risk factor X) included in a risk control rule and/or risk control module and risk information sets (infocode A, infocode B, . . . , and infocode X).

Each risk information set includes corresponding multiple levels of risk information. For example, infocode A includes three levels of risk information that are refined level by level: codeA1, codeA2, and codeA3.

A third part is infocode output used to hierarchically output multiple levels of risk information to service owners who match risk information requirement levels.

There are three risk information requirement levels: a weak management and control merchant, a general management and control merchant, and a strong management and control merchant. The weak management and control merchant can be a small-sized merchant or new merchant who has no risk control capability or does not focus on risk control. The general management and control merchant can be a small- or medium-sized merchant who has a certain risk control capability but has no professional risk control team. The strong management and control merchant can be a medium- or large-sized merchant who has a stronger risk control capability and has established a professional risk control team.

In actual applications, a server can analyze each payment service in real time, and can output infocode at a corresponding level to an owner of a service when outputting a risk control decision result such as “rejecting the service” or “accepting the service” with reference to a risk control rule and a risk control model.

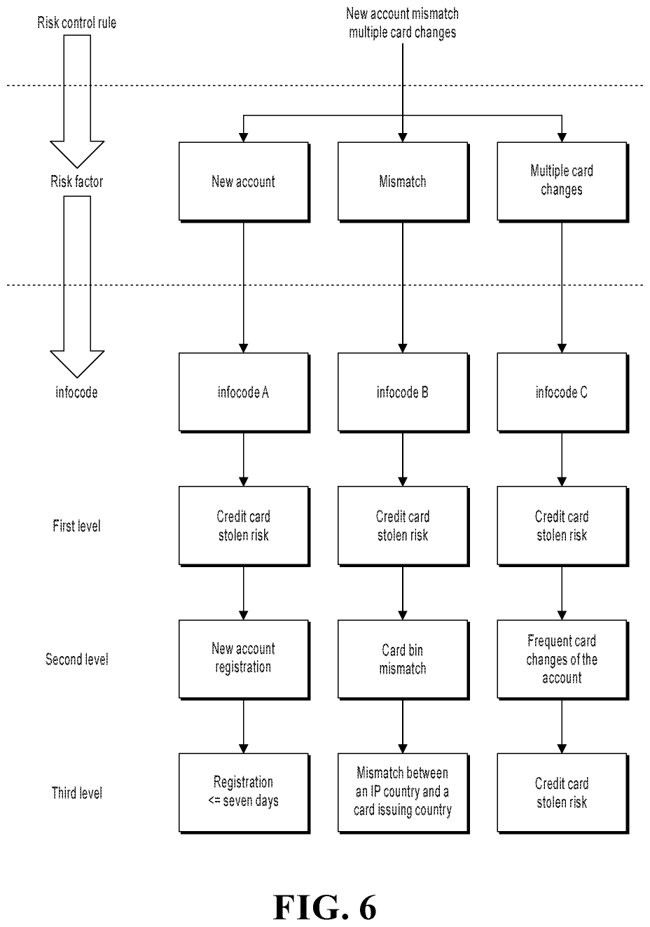

As shown in FIG. 6, an implementation of the present application further provides an example diagram illustrating a three-layer infocode framework in a risk control scenario of a payment service.

In FIG. 6, an applied risk control rule is referred to as “new account mismatch multiple card changes”, and can be split into three risk factors: “new account”, “mismatch”, and “multiple card changes”.

Each risk factor corresponds to one infocode set. The risk factor can be described in a more detailed dimension, and then three levels of infocode can be constructed. The three levels of infocode constitute one infocode set. For example, “mismatch” indicates a credit card stolen risk and an account takeover risk (which can be used as first-level infocode). Further, the credit card stolen risk can be classified into a card bin mismatch, a device mismatch, etc. (which can be used as second-level infocode). Further, the card bin mismatch can be classified into a mismatch between a card issuing country and an IP country, a mismatch between the card issuing country and a card shipping country and so on (which can be used as third-level infocode).

Based on the solutions in FIG. 5 and FIG. 6, a positive interaction between a payment service platform and a merchant can be effectively enhanced, and payment risk control experience can be enhanced.

It is worthwhile to note that in all of the previous examples, “three levels of risk information” is used as the “multiple levels of risk information”. In actual applications, the multiple levels of risk information can be two levels of risk information, more than three levels of risk information, etc. In addition, the solutions of the present application can be implemented for all or some risk factors.

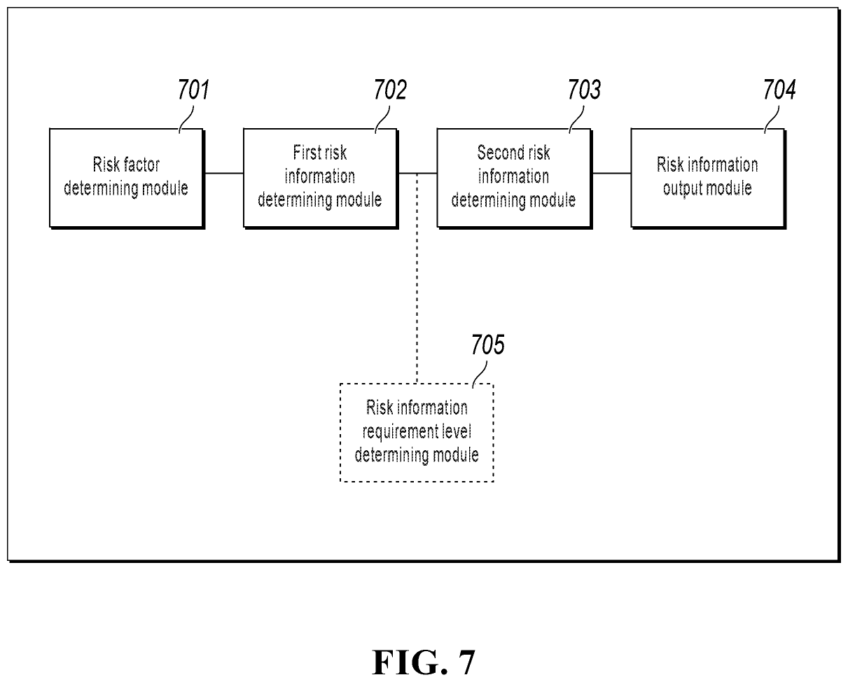

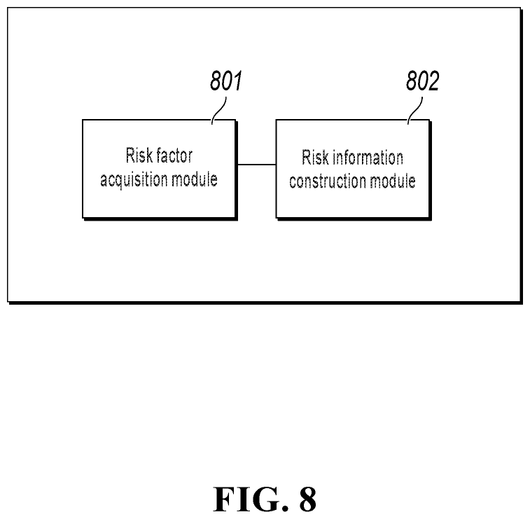

The method for outputting risk information and the method for constructing risk information provided in the implementations of the present application are described above. Based on the same idea, as shown in FIG. 7 and FIG. 8, the implementations of the present application further provide a corresponding device for outputting risk information and a corresponding device for constructing risk information.

FIG. 7 is a schematic structural diagram illustrating a device for outputting risk information corresponding to FIG. 1, according to an implementation of the present application. The device includes the following: a risk factor determining module 701, configured to determine, based on a predetermined risk control rule and/or risk control model that include/includes one or more risk factors, a risk factor that corresponds to a risk control decision result of a service from the risk factors, where the risk control decision result is determined based on the risk control rule and/or risk control model and service data that relates to the corresponding risk factor; a first risk information determining module 702, configured to determine a risk information set that corresponds to the corresponding risk factor, where the corresponding risk information set includes multiple levels of risk information with different refinement degrees, and the risk information is used to explain a cause of the risk control decision result; a second risk information determining module 703, configured to determine one or more levels of risk information with refinement degrees that match a risk information requirement level of a service owner from the multiple levels of risk information based on the risk information requirement level of the service owner; and a risk information output module 704, configured to output the determined risk information, so that the service owner obtains the determined risk information.

Optionally, a correspondence is established between each risk factor included in the risk control rule and/or risk control model and one predetermined risk information set.

The first risk information determining module 702 is configured to determine the risk information set that corresponds to the corresponding risk factor from predetermined risk information sets based on the correspondence.

Optionally, the device further includes the following: a risk information requirement level determining module 705, configured to determine the risk information requirement level that is of the service owner and that is specified in a predetermined configuration file, before the second risk information determining module 703 determines the one or more levels of risk information with the refinement degrees that match the risk information requirement level of the service owner; or infer the risk information requirement level of the service owner from obtained risk control level information and/or risk control requirement information of the service owner.

Optionally, the risk information output module 704 is configured to output the determined risk information to the service owner when outputting the risk control decision result to the service owner.

Optionally, the risk information requirement level of the service owner is one of multiple predetermined risk information requirement levels, and it is used to indicate a risk information requirement degree and/or depth of the service owner.

The multiple risk information requirement levels are in a one-to-one correspondence with and match the multiple levels of risk information, and a risk information requirement level that indicates a higher risk information requirement degree and/or depth matches a level of risk information with a higher refinement degree in the multiple levels of risk information.

Optionally, the multiple levels of risk information are constructed based on the risk control rule and/or risk control model and related historical risk control experience data, and are described by using a method that can be easily understood by the service owner.

Optionally, the risk control decision result of the service includes rejecting the service, accepting the service, or needing to manually review the service.

Optionally, the service includes a payment service, and the service owner includes a merchant that corresponds to the payment service.

The device in FIG. 7 can be located on a server or a terminal device.

FIG. 8 is a schematic structural diagram illustrating a device for constructing risk information corresponding to FIG. 4, according to an implementation of the present application. The device includes the following: a risk factor acquisition module 801, configured to split a predetermined risk control rule and/or risk control model, to obtain one or more risk factors included in the risk control rule and/or risk control model; and a risk information construction module 802, configured to construct a corresponding risk information set for each obtained risk factor, where the corresponding risk information set includes multiple levels of risk information with different refinement degrees, the risk information is used to explain a cause of a risk control decision result of a service, and the risk control decision result is determined based on the risk control rule and/or risk control model and service data that relates to the corresponding risk factor, so that one or more levels of risk information with refinement degrees that match a risk information requirement level of a service owner are determined from the multiple levels of risk information based on the risk information requirement level of the service owner, and are output to the service owner when the risk control decision result is output.

The device in FIG. 8 can be located on a server or a terminal device.

It is worthwhile to note that the devices provided in the present application are in a one-to-one correspondence with the methods provided in the present application. Therefore, the devices and the methods have similar beneficial technical effects. The beneficial technical effects of the methods have been described above in detail, and therefore the beneficial technical effects of the devices are omitted here for simplicity.

A person skilled in the art should understand that the implementations of the present disclosure can be provided as a method, a system, or a computer program product. Therefore, the present disclosure can use a form of hardware only implementations, software only implementations, or implementations with a combination of software and hardware. In addition, the present disclosure can use a form of a computer program product that is implemented on one or more computer-usable storage media (including, but not limited to, a magnetic disk storage, a CD-ROM, an optical memory, etc.) that include computer-usable program code.

The present disclosure is described with reference to the flowcharts and/or block diagrams of the method, the device (system), and the computer program product according to the implementations of the present disclosure. It should be understood that computer program instructions can be used to implement each process and/or each block in the flowcharts and/or the block diagrams and a combination of a process and/or a block in the flowcharts and/or the block diagrams. These computer program instructions can be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more processes in the flowcharts and/or in one or more blocks in the block diagrams.

These computer program instructions can be stored in a computer readable memory that can instruct the computer or the another programmable data processing device to work in a specific way, so that the instructions stored in the computer readable memory generate an artifact that includes an instruction apparatus. The instruction apparatus implements a specific function in one or more processes in the flowcharts and/or in one or more blocks in the block diagrams.

These computer program instructions can be loaded onto the computer or the another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, a computing device includes one or more processors (CPU), an input/output interface, a network interface, and a memory.

The memory can include a non-persistent storage, a random access memory (RAM), a non-volatile memory, and/or another form that are in a computer readable medium, for example, a read-only memory (ROM) or a flash memory (flash RAM). The memory is an example of the computer readable medium.

The computer readable medium includes persistent, non-persistent, movable, and unmovable media that can store information by using any method or technology. The information can be a computer readable instruction, a data structure, a program module, or other data. A computer storage medium includes, but is not limited to, a phase-change random access memory (PRAM), a static random access memory (SRAM), a dynamic random access memory (DRAM), a random access memory (RAM) of another type, a read-only memory (ROM), an electrically erasable programmable read only memory (EEPROM), a flash memory or another memory technology, a compact disc read-only memory (CD-ROM), a digital versatile disc (DVD), or another optical storage, a cassette, a cassette magnetic disk storage, or another magnetic storage device or any other non-transmission medium. The computer storage medium can be configured to store information that can be accessed by the computing device. Based on the definition in the present specification, the computer readable medium does not include computer readable transitory media (transitory media), for example, a modulated data signal and carrier.

It is worthwhile to further note that the terms “include”, “comprise”, and any other variants of them are intended to cover a non-exclusive inclusion, so that a process, a method, an article, or a device that includes a list of elements not only includes those elements but also includes other elements that are not expressly listed, or further includes elements inherent to such process, method, article, or device. An element proceeded by “includes a . . . ” does not, without more constraints, preclude the existence of additional identical elements in the process, method, article, or device that includes the element.

The previous descriptions are merely implementations of the present application, and are not intended to limit the present application. For a person skilled in the art, the present application can have various modifications and changes. Any modification, equivalent substitution, improvement, etc. made based on the spirit and principle of the present application shall fall in the scope of the claims in the present application.

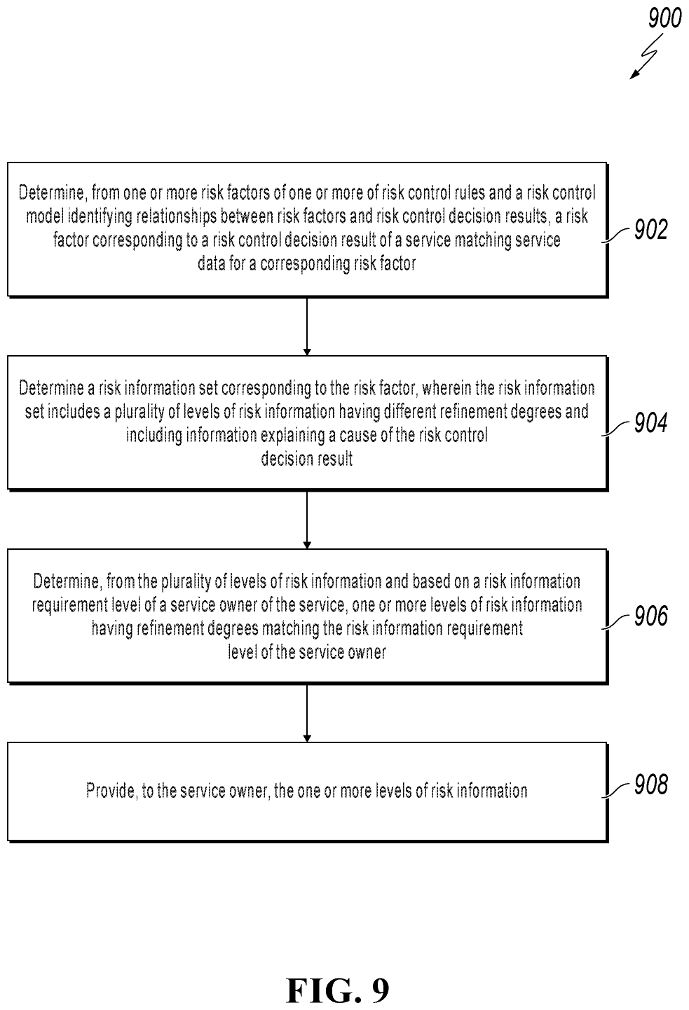

FIG. 9 is a flowchart illustrating an example of a computer-implemented method 900 for determining and providing one or more levels of risk information for risk factors corresponding to a risk control decision result of a service owner, according to an implementation of the present disclosure. For clarity of presentation, the description that follows generally describes method 900 in the context of the other figures in this description. However, it will be understood that method 900 can be performed, for example, by any system, environment, software, and hardware, or a combination of systems, environments, software, and hardware, as appropriate. In some implementations, various steps of method 900 can be run in parallel, in combination, in loops, or in any order.

At 902, a risk factor is determined from one or more risk factors of one or more of risk control rules and a risk control model identifying relationships between risk factors and risk control decision results. The risk factor corresponds to a risk control decision result of a service owner, matching service data for a corresponding risk factor. The risk control decision result of the service owner can be, for example, rejection of the service, acceptance of the service, or an indication that manual review of the service is necessary. The service can be, for example, a payment service, and the service owner can be a merchant of the payment service. Risk factors can be determined, for example, by the risk factor determining module 701. Risk factors for a service owner can depend, for example, on how much industry experience is held by the service owner and the extent to which the service owner uses risk control capabilities. For example, experienced merchants in an industry may prefer to see various risk signals of services behind risk control decision results in order to improve their own risk control levels and better understand current risk trends. However, new merchants in an industry who are more engaged in market expansion may not have a professional team for receiving and processing professional risk information output. As a result, experienced merchants typically have fewer (and reduced levels of) risk factors than less-experienced merchants. Merchants having more experience can have a greater chance of making a good risk control decision and, consequentially, a good risk control decision result. From 902, method 900 proceeds to 904.

At 904, a risk information set corresponding to the risk factor is determined. The risk information set includes a plurality of levels of risk information having different refinement degrees and including information explaining a cause of the risk control decision result. The risk information set can be determined, for example, by first risk information determining module 702. Risk information in the risk information set can be used to explain a cause of a risk control decision result of a service. Example risk information sets are described with reference to FIG. 2 and FIG. 3, which collectively provide a schematic diagram illustrating risk information sets constructed for risk factors in a risk control scenario of a payment service.

In some implementations, method 900 can further include determining a correspondence between the risk information set and the one or more risk factors in the risk control rules and the risk control model. As an example, the risk control decision result can be determined based on the risk control rule and/or risk control model and service data that relates to the corresponding risk factor. One or more levels of the risk information can have refinement degrees that match a risk information requirement level of a service owner. The refinement degrees can be determined from the multiple levels of risk information based on the risk information requirement level of the service owner. The refinement degrees can correspond to lower branches on the tree structures presented in FIG. 2 and FIG. 3. From 904, method 900 proceeds to 906.

At 906, one or more levels of risk information having refinement degrees matching the risk information requirement level of the service owner are determined from the plurality of levels of risk information. For example, the second risk information determining module 703 can determine the one or more levels of risk information based on a risk information requirement level of a service owner of the service. The one or more levels of risk information can correspond to the risk information sets constructed for risk factors in the risk control scenario of the payment service described with reference to FIG. 2 and FIG. 3.

In some implementations, the risk information requirement level of the service owner can be one of multiple predetermined risk information requirement levels. For example, each of the multiple predetermined risk information requirement levels can indicate a risk information requirement degree of the service owner or a risk information requirement depth of the service owner.

In some implementations, the plurality of levels of risk information can be constructed based on one or more of the risk control rules, the risk control model, and historical risk control experience data. For example, the risk information construction module 802 can construct plurality of levels of risk information. The historical risk control experience data can include information about experiences collected over time for historical services provided by different service owners.

In some implementations, method 900 can further include steps for inferring the risk information requirement level of the service owner. For example, before the determination of the one or more levels of risk information, risk control requirement information of the service owner can be determined using a predetermined configuration file. The risk information requirement level of the service owner can be inferred from the risk control requirement information of the service owner. From 906, method 900 proceeds to 908.

At 908, the one or more levels of risk information are provided to the service owner. For example, the risk information output module 704 can output the determined risk information, so that the service owner can obtain the determined risk information.

In some implementations, providing the one or more levels of risk information can include outputting the one or more levels of risk information to the service owner. For example, information provided by the risk information output module 704 can be organized hierarchically by levels, consistent with the risk information sets described with reference to FIG. 2 and FIG. 3. From 908, method 900 stops.

In some implementations, method 900 can further include providing to the service owner a description describing how the plurality of levels of risk information are determined. For example, the risk information output module 704 can provide a description that describes how the risk information is organized hierarchically by levels and how the information is determined.

Techniques described in the present disclosure can improve the amount of risk information that is provided to a service owner. For example, before and after the service owner makes a risk control decision, the risk information can be used as a tool to better understand risks associated with decisions and how the risks are related. In this way, the service owner can simultaneously see the risk information and the corresponding risk control decision result. This can result in the service owner having a better experience and can allow the service owner to perform targeted subsequent processing on the service based on the transaction information. For example, the service owner can use the risk information to perform actions before re-submitting the service after a particular risk is eliminated.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, Institute of Electrical and Electronics Engineers (IEEE) 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

What is claimed is:

1. A computer-implemented method, comprising:
determining, from one or more risk factors of one or more of risk control rules and a risk control model identifying relationships between risk factors and risk control decision results, a risk factor corresponding to a risk control decision result of a service matching service data for a corresponding risk factor;
determining a risk information set corresponding to the risk factor, wherein the risk information set includes a plurality of levels of risk information having different refinement degrees and including information explaining a cause of the risk control decision result;
determining, from the plurality of levels of risk information and based on a risk information requirement level of a service owner of the service, one or more levels of risk information having refinement degrees matching the risk information requirement level of the service owner; and
providing, to the service owner, the one or more levels of risk information.

2. The computer-implemented method of claim 1, further comprising determining a correspondence between the risk information set and the one or more risk factors in the risk control rules and the risk control model.

3. The computer-implemented method of claim 1, further comprising:
before the determination of the one or more levels of risk information, determining, using a predetermined configuration file, risk control requirement information of the service owner; and
inferring the risk information requirement level of the service owner from the risk control requirement information of the service owner.

4. The computer-implemented method of claim 1, wherein providing the one or more levels of risk information includes outputting the one or more levels of risk information to the service owner when providing the one or more levels of risk information to the service owner.

5. The computer-implemented method of claim 1, wherein the risk information requirement level of the service owner is one of multiple predetermined risk information requirement levels, wherein each of the multiple predetermined risk information requirement levels indicates a risk information requirement degree of the service owner or a risk information requirement depth of the service owner.

6. The computer-implemented method of claim 1, wherein the plurality of levels of risk information are constructed based on the risk control rules, the risk control model, and historical risk control experience data.

7. The computer-implemented method of claim 1, further comprising providing, to the service owner, a description describing how the plurality of levels of risk information are determined.

8. The computer-implemented method of claim 1, wherein the risk control decision result of the service owner includes rejecting the service, accepting the service, or a need to manually review the service.

9. The computer-implemented method of claim 1, wherein the service is a payment service, and wherein the service owner is a merchant of the payment service.

10. A non-transitory, computer-readable medium storing one or more instructions executable by a computer system to perform operations comprising:
determining, from one or more risk factors of one or more of risk control rules and a risk control model identifying relationships between risk factors and risk control decision results, a risk factor corresponding to a risk control decision result of a service matching service data for a corresponding risk factor;
determining a risk information set corresponding to the risk factor, wherein the risk information set includes a plurality of levels of risk information having different refinement degrees and including information explaining a cause of the risk control decision result;
determining, from the plurality of levels of risk information and based on a risk information requirement level of a service owner of the service, one or more levels of risk information having refinement degrees matching the risk information requirement level of the service owner; and
providing, to the service owner, the one or more levels of risk information.

11. The non-transitory, computer-readable medium of claim 10, the operations further comprising determining a correspondence between the risk information set and the one or more risk factors in the risk control rules and the risk control model.

12. The non-transitory, computer-readable medium of claim 10, the operations further comprising:
before the determination of the one or more levels of risk information, determining, using a predetermined configuration file, risk control requirement information of the service owner; and
inferring the risk information requirement level of the service owner from the risk control requirement information of the service owner.

13. The non-transitory, computer-readable medium of claim 10, wherein providing the one or more levels of risk information includes outputting the one or more levels of risk information to the service owner when providing the one or more levels of risk information to the service owner.

14. The non-transitory, computer-readable medium of claim 10, wherein the risk information requirement level of the service owner is one of multiple predetermined risk information requirement levels, wherein each of the multiple predetermined risk information requirement levels indicates a risk information requirement degree of the service owner or a risk information requirement depth of the service owner.

15. The non-transitory, computer-readable medium of claim 10, wherein the plurality of levels of risk information are constructed based on the risk control rules, the risk control model, and historical risk control experience data.

16. The non-transitory, computer-readable medium of claim 10, the operations further comprising providing, to the service owner, a description describing how the plurality of levels of risk information are determined.

17. The non-transitory, computer-readable medium of claim 10, wherein the risk control decision result of the service owner includes rejecting the service, accepting the service, or a need to manually review the service.

18. The non-transitory, computer-readable medium of claim 10, wherein the service is a payment service, and wherein the service owner is a merchant of the payment service.

19. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
determining, from one or more risk factors of one or more of risk control rules and a risk control model identifying relationships between risk factors and risk control decision results, a risk factor corresponding to a risk control decision result of a service matching service data for a corresponding risk factor;
determining a risk information set corresponding to the risk factor, wherein the risk information set includes a plurality of levels of risk information having different refinement degrees and including information explaining a cause of the risk control decision result;
determining, from the plurality of levels of risk information and based on a risk information requirement level of a service owner of the service, one or more levels of risk information having refinement degrees matching the risk information requirement level of the service owner; and
providing, to the service owner, the one or more levels of risk information.

20. The computer-implemented system of claim 19, the operations further comprising determining a correspondence between the risk information set and the one or more risk factors in the risk control rules and the risk control model.
